(19) United States
(12) Patent Application Publication
(10) Pub. No.: US 2004/0226430 A1
(43) Pub. Date: Nov. 18, 2004

(54) Musical string networks

(76) Inventors: Samuel Gaudet, Moncton (CA); Claude Gauthier, Dieppe (CA)

Correspondence Address: INVENTARIUM, SUITE 1607, 4050, ROSEMONT BLVD, MONTREAL, QC, H1X2M4, CA

(21) Appl. No.: 10/844,916

(22) Filed: May 12, 2004

Related U.S. Application Data
(60) Provisional application No. 60/469,590, filed on May 12, 2003.

(51) Int. Cl. G09G 3/10; G10D 1/00; G10H 1/00

(52) U.S. Cl. 84/173

(57) ABSTRACT

The basic premise of this invention is to describe and reduce to practice a phenomena by which a string—which is generally known as a singular straight line having a certain tension, diameter and length that produces a vibration—can, when put in a network consisting of a plurality of strings connected together at one or more junction points and radiating therefrom, create a new entity known as a <<network of strings>> which has new vibrating properties. As the vibration, in the form of a wave, travels through a first segment of the network, it splits at the first junction point met where it will travel onto at least one other string but preferably two or more strings. Transferring the original wave's energy over to the other strings in the network makes them vibrate as well and when the waves in the other strings come back to the junction, another transfer of energy occurs and part of the vibrations, which was altered by the properties of each given string, creates a pattern of vibrations which can be added or subtracted which results in complex wave patterns.

This application claims priority based on provisional application 60/469,590 filed May 12, 2003 for claims 1 and 2

### BACKGROUND OF THE INVENTION

1. Field of the Invention

This invention relates generally to musical instruments but more particularly to instruments using one or more networks of interconnected strings that resonate as networks.

2. Background

String instruments have been known since prehistory and Pythagoras was the first known scientist to describe some basic properties such as vibrating strings producing harmonious tones when the ratios of the lengths of the strings are whole numbers, and that these ratios can be extended to other instruments. Over the following centuries, advances in physics and mathematics have made it possible to more closely analyze and understand waves traveling through physical strings. As a result, new and unexpected results can be achieved and new sounds can be produced by musical instruments not imagined before.

### SUMMARY OF THE INVENTION

The basic premise of this invention is to describe and reduce to practice a phenomena by which a string—which is generally known as a singular straight line having a certain tension, diameter and length that produces a vibration—can, when put in a network consisting of a plurality of strings connected together at one or more junction points and radiating therefrom, create a new entity known as a <<network of strings >> which has new vibrating properties. As the vibration, in the form of a wave, travels through a first segment of the network, it splits at the first junction point met where it will travel onto at least one other string but preferably two or more strings. Transferring the original wave's energy over to the other strings in the network makes them vibrate as well and when the waves in the other strings come back to the junction, another transfer of energy occurs and part of the vibrations, which was altered by the properties of each given string, creates a pattern of vibrations which can be added or subtracted which results in complex wave patterns.

Experimentally, string networks have been created on three necked guitar like instruments with a plurality of sets of three strings radiating from the junction point for each of the plurality of sets of three strings. In order to build a guitar like instrument and understand how it will work and predict the type of frequencies it will produce, it is important to apply a mathematical formula described herein.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

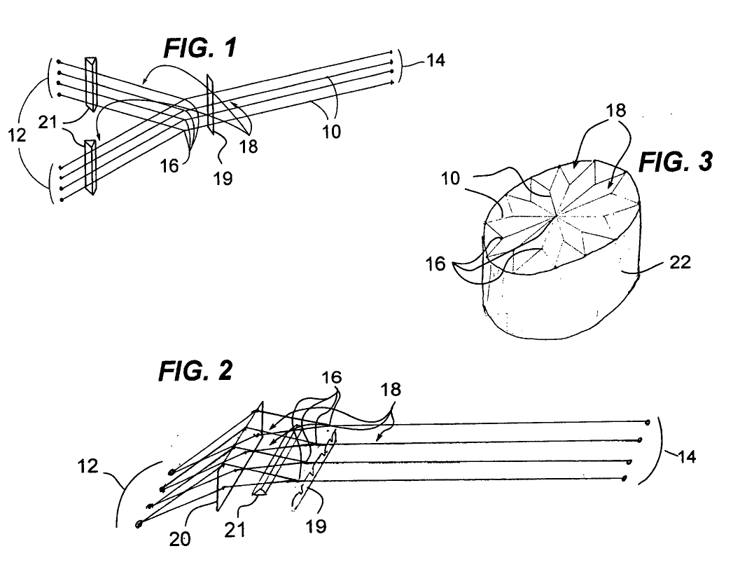

FIG. 1 Perspective view of a triad network for a guitar like instrument.

FIG. 2 Perspective view of a triad network for a violin like instrument.

FIG. 3 Perspective view of a multiple network for a percussion instrument.

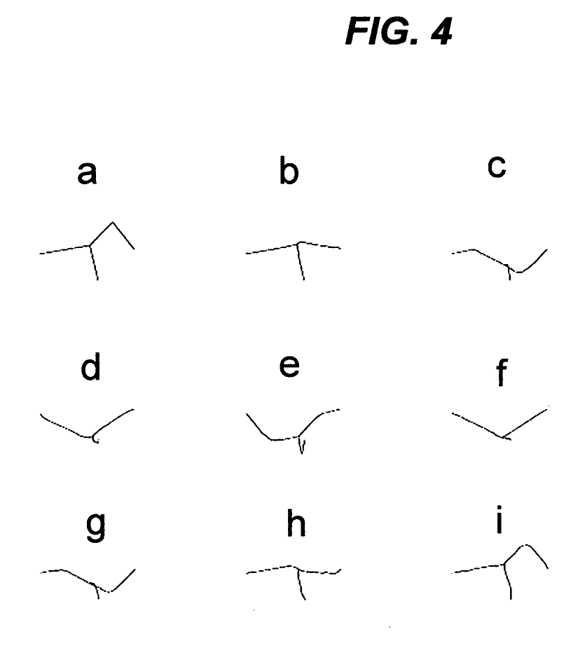

FIG. 4 Diagrams of a computer simulation of wave pattern.

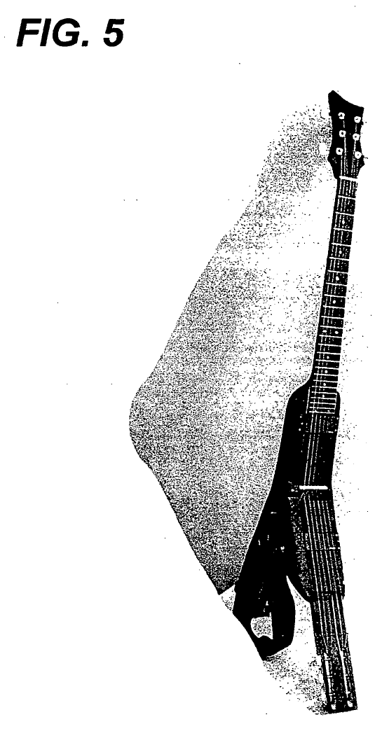

FIG. 5 Perspective view of a guitar like instrument.

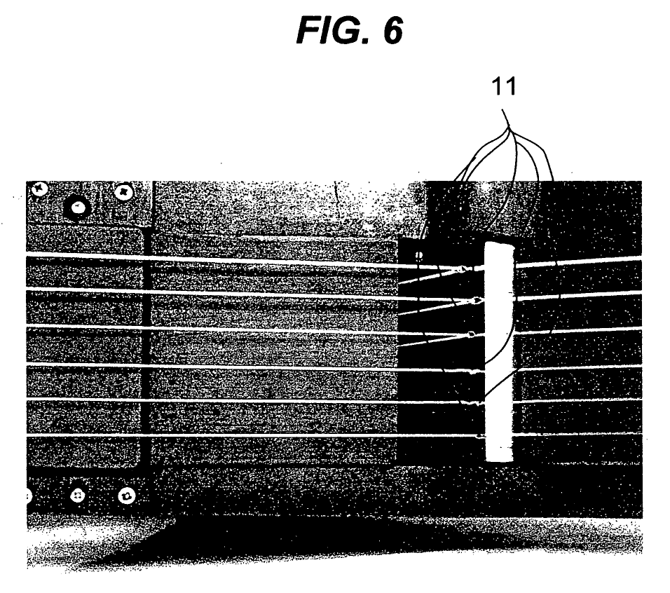

FIG. 6 Close up view of the connection means at the junction point.

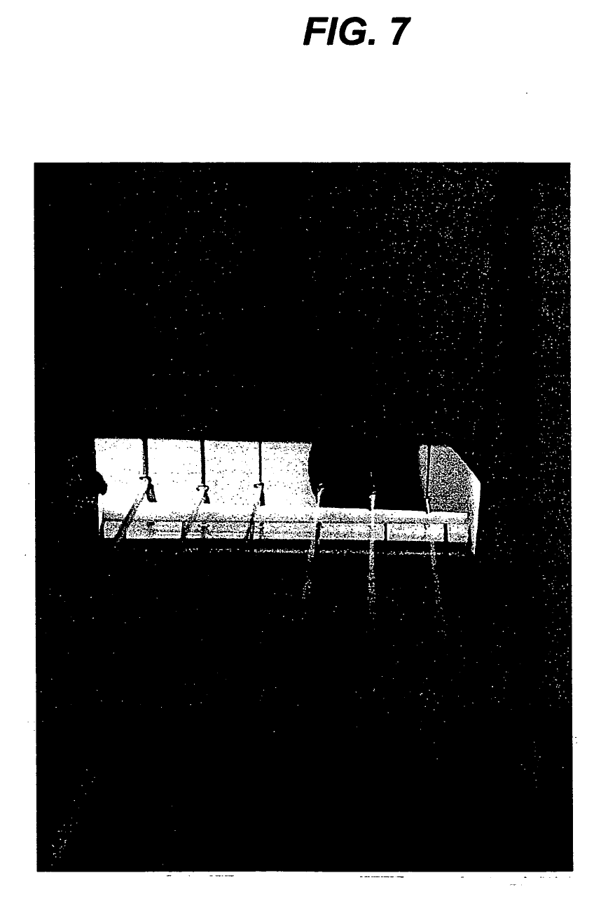

FIG. 7 Alternate close up view of the connection means at the junction point.

### DETAILED DESCRIPTION OF THE PREFERRED EMBODIMENT

As shown in FIGS. 1-2, in a network of strings (18) some strings (10) are fixedly attached to fixed points (12) while others are fixedly attached to a tunable point (14). As shown in FIG. 5, all points can be tunable while some can be fixed. Each set of strings (10) in a network of strings (18) meets at a junction point (16) which is from where new tonalities can be created. To increase versatility, by using a movable stopper (19) an instrument can be converted to a regular instrument (example a guitar) by moving the stopper (19) in a position in which it makes physical contact with the strings so as to separate the strings (10) on one side of the stopper (19) from the strings (10) on the other side of the stopper (19). In this configuration, the network of strings (18) is no longer active and the instrument can be played like a regular instrument of its type. By disengaging the movable stopper (19) from the strings (10) so that there is no physical contact between the stopper (19) and the strings (10), re-establishes the network of strings (18). Movable bridges (21) act like those found on regular instruments such as guitars or violins but are movable so that they can be selectively positioned at various points along the strings (10) so as to vary the ratio between the frequencies that make up the spectre of frequencies produced by the instrument. The stopper (19) is very similar to the bridge (21) in the sense that both have the same purpose of stopping the vibrations in the strings, so it could be conceivable that the stopper (19) could be selectively positioned at various points along the strings (10).

The principle of network of strings (18) can also be applied to other stringed instruments, such as the violin like instrument of FIG. 2 where a bridge (20) has two levels.

In FIG. 3, a percussion instrument having a frame (22) can also be built using a complex network of strings (18) having one or more junction points (16).

Complex frequency patterns can be generated as shown in the series of computer generated diagrams of FIG. 4 shown here as examples of the many possibilities. In these examples, amplitude has been exagerated to better visualize the movement.

FIG. 5-7 show one method of creating network of strings (18) by having one string (10) terminating in a loop (11), and through this loop (11) passes another string (10′). Another method of creating a network of strings (18) is to create it during manufacturing process which is feasible for thicker strings wherein a string is wound around a thinner string as is well known in the art but in the case of thinner strings, such a process does not yet exist and could be part of another patent application.

Although real prototypes were built using angles of 60 or 120 or 150 degrees between strings (10) in the network of strings (18), there are a multitude of angles possible, each having its own characteristic wave pattern. In order to determine the sound possibilities of an instrument, the wave pattern of the network of strings (18) can be predicted using mathematical formulas and can be obtained using different methods. As mathematical science evolves, different mathematical means could be employed that are either simpler to apply or which can give better results over a wider variety of parameters. The following mathematical formula is given as one example of possible means to predict the behavior of the network of strings (18) under various parameters:

In the case of a network having one junction point for N sections of string whose lengths, mass densities and tensions are respectively designated li, di and Ti, i=1, 2, . . . , N, the eigenvalues allowing one to establish the corresponding vibration frequency spectrum of the network are the solutions of

$${\sum }_{i = 1}^{N} [ \frac{{n}_{i}}{{n}_{1}} cos ( \frac{{l}_{i} r}{{c}_{i}} ) {\prod }_{{j = 1}_{j \neq i}}^{N} sin ( \frac{{l}_{i} r}{{c}_{j}} ) ] = 0$$

where cᵢ=\sqrt{Tᵢ/dᵢ} and nᵢ=cᵢdᵢ. If rₖ, k=1, 2, . . . , are the roots of this equation, then the corresponding eigenfunctions are

$$\begin{matrix}{P}_{k} ( x ) = [ cos \frac{{l}_{1} {r}_{k} x}{π {c}_{1}} + ( \frac{{n}_{2}}{{n}_{1}} cot \frac{{l}_{2} {r}_{k}}{{c}_{2}} + … + \frac{{n}_{N}}{{n}_{1}} cot \frac{{l}_{N} {r}_{k}}{{c}_{N}} ) sin \frac{{l}_{1} {r}_{k} x}{π {c}_{1}} , \\ cos \frac{{l}_{2} {r}_{k} x}{π {c}_{2}} - ( cot \frac{{l}_{2} {r}_{k}}{{c}_{2}} ) sin \frac{{l}_{2} {r}_{k} x}{π {c}_{2}} , … , cos \frac{{l}_{N} {r}_{k} x}{π {c}_{N}} - \\ { ( cot \frac{{l}_{N} {r}_{N}}{{c}_{N}} ) sin ( \frac{{l}_{N} {r}_{k} x}{π {c}_{N}} ) ]}^{T}\end{matrix}$$

If uⁱ(xᵢ,t),i=1, 2, . . . , N, 0≦xᵢ≦lᵢ,t≧0 designate the position of the point xᵢ at time t, and

uⁱ(xᵢ,0)=Fⁱ(xᵢ), uₜⁱ(xᵢ,0)=Gⁱ(xᵢ),

are the initial displacement and velocity, respectively, then the vibrations of the network are described by

uⁱ(xᵢ,t)=vⁱ(πxᵢ/lᵢ,t),

where

$${[ {v}^{1} ( x , t ) , {v}^{2} ( x , t ) , … , {v}^{N} ( x , t ) ]}^{T} = {\sum }_{k = 1}^{∞} ( {a}_{k} cos {r}_{k} t + \hat{a} sin {r}_{k} t ) {P}_{k} ( x )$$

$${a}_{k} = \frac{{⟨ ⟨ F , {P}_{k} ⟩ ⟩}_{L}}{{⟨ ⟨ {P}_{k} , {P}_{k} ⟩ ⟩}_{L}} , \qquad {\hat{a}}_{k} = \frac{{⟨ ⟨ G , {P}_{k} ⟩ ⟩}_{L}}{{r}_{k} {⟨ ⟨ {P}_{k} , {P}_{k} ⟩ ⟩}_{L}} ,$$

$$F ( x ) = {[ {F}^{1} ( {l}_{1} x / π ) , {F}^{2} ( {l}_{2} x / π ) , … , {F}^{N} ( {l}_{N} x / π ) ]}^{T} , \\ G ( x ) = {[ {G}^{1} ( {l}_{1} x / π ) , {G}^{2} ( {l}_{2} x / π ) , … , {G}^{N} ( {l}_{N} x / π ) ]}^{T} , \\ with the scalar product ⟨ ⟨ ⟩ ⟩ defined by$$

$$⟨ ⟨ f ( x ) , g ( x ) ⟩ ⟩ = {\int }_{0}^{π} ( {\sum }_{i = 1}^{N} {l}_{i} {d}_{i} {f}_{i} ( x ) {g}_{i} ( x ) ) ⅆ x , \\ where f ( x ) = {( {f}_{1} ( x ) , {f}_{2} ( x ) , … , {f}_{N} ( x ) )}^{T}$$

$$and g ( x ) = {( {g}_{1} ( x ) , {g}_{2} ( x ) , … , {g}_{N} ( x ) )}^{T} .$$

1. A network of strings comprising
strings having a proximal end and a distal end and said strings having their proximal ends joined at a junction point and radiating therefrom and each said strings having their said distal ends attached.

2. A network of strings having a mode of operation described by the following equation:
In the case of a network having one junction point for N sections of string whose lengths, mass densities and tensions are respectively designated li, di and Ti, i=1, 2, . . . , N, the eigenvalues allowing one to establish the corresponding vibration frequency spectrum of the network are the solutions of
$${\sum }_{i = 1}^{N} [ \frac{{n}_{i}}{{n}_{1}} cos ( \frac{{l}_{i} r}{{c}_{i}} ) {\prod }_{{j = 1}_{j \neq i}}^{N} sin ( \frac{{l}_{i} r}{{c}_{j}} ) ] = 0$$
where cᵢ=\sqrt{Tᵢ/dᵢ} and nᵢ=cᵢdᵢ. If rₖ, k=1, 2, . . . , are the roots of this equation, then the corresponding eigenfunctions are
$$\begin{matrix}{P}_{k} ( x ) = [ cos \frac{{l}_{1} {r}_{k} x}{π {c}_{1}} + ( \frac{{n}_{2}}{{n}_{1}} cot \frac{{l}_{2} {r}_{k}}{{c}_{2}} + … + \frac{{n}_{N}}{{n}_{1}} cot \frac{{l}_{N} {r}_{k}}{{c}_{N}} ) sin \frac{{l}_{1} {r}_{k} x}{π {c}_{1}} , \\ cos \frac{{l}_{2} {r}_{k} x}{π {c}_{2}} - ( cot \frac{{l}_{2} {r}_{k}}{{c}_{2}} ) sin \frac{{l}_{2} {r}_{k} x}{π {c}_{2}} , … , cos \frac{{l}_{N} {r}_{k} x}{π {c}_{N}} - \\ { ( cot \frac{{l}_{N} {r}_{N}}{{c}_{N}} ) sin ( \frac{{l}_{N} {r}_{k} x}{π {c}_{N}} ) ]}^{T}\end{matrix}$$
If uⁱ(xᵢ,t), i=1, 2, . . . , N, 0≦xᵢ≦lᵢ,t≧0 designate the position of the point xᵢ at time t, and
uⁱ(xᵢ, 0)=Fⁱ(xᵢ), uₜⁱ(xᵢ,0)=Gⁱ(xᵢ),
are the initial displacement and velocity, respectively, then the vibrations of the network are described by
uⁱ(xᵢ,t)=vⁱ(πxᵢ/lᵢ,t),
where
$${[ {v}^{1} ( x , t ) , {v}^{2} ( x , t ) , … , {v}^{N} ( x , t ) ]}^{T} = {\sum }_{k = 1}^{∞} ( {a}_{k} cos {r}_{k} t + \hat{a} sin {r}_{k} t ) {P}_{k} ( x )$$
$${a}_{k} = \frac{{⟨ ⟨ F , {P}_{k} ⟩ ⟩}_{L}}{{⟨ ⟨ {P}_{k} , {P}_{k} ⟩ ⟩}_{L}} , \qquad {\hat{a}}_{k} = \frac{{⟨ ⟨ G , {P}_{k} ⟩ ⟩}_{L}}{{r}_{k} {⟨ ⟨ {P}_{k} , {P}_{k} ⟩ ⟩}_{L}} ,$$
$$F ( x ) = {[ {F}^{1} ( {l}_{1} x / π ) , {F}^{2} ( {l}_{2} x / π ) , … , {F}^{N} ( {l}_{N} x / π ) ]}^{T} , \\ G ( x ) = {[ {G}^{1} ( {l}_{1} x / π ) , {G}^{2} ( {l}_{2} x / π ) , … , {G}^{N} ( {l}_{N} x / π ) ]}^{T} , \\ with the scalar product ⟨ ⟨ ⟩ ⟩ defined by$$
$$⟨ ⟨ f ( x ) , g ( x ) ⟩ ⟩ = {\int }_{0}^{π} ( {\sum }_{i = 1}^{N} {l}_{i} {d}_{i} {f}_{i} ( x ) {g}_{i} ( x ) ) ⅆ x , \\ where f ( x ) = {( {f}_{1} ( x ) , {f}_{2} ( x ) , … , {f}_{N} ( x ) )}^{T}$$
$$and g ( x ) = {( {g}_{1} ( x ) , {g}_{2} ( x ) , … , {g}_{N} ( x ) )}^{T} .$$

3. A network of strings as in claim 1 wherein:
a movable stopper movable between a position where it makes physical contact with strings so as to separate the strings on one side of said stopper from strings on the other side of said stopper wherein in this configuration, the network of strings is no longer active and by disengaging said movable stopper from said strings so that there is no physical contact between said stopper and said strings so as to re-establish said network of strings.

4. A network of strings as in claim 1 wherein
a movable bridge can be selectively positioned at various points along said strings so as to vary the ratio of frequencies.

5. A network of strings as in claim 1 wherein
said stopper can be selectively positioned at various points along said strings.
